(19) United States
(12) Patent Application Publication
(10) Pub. No.: US 2026/0175253 A1
(43) Pub. Date: Jun. 25, 2026

(54) POWDER SUPPLY DEVICE FOR MANUFACTURING DRY ELECTRODES

(71) Applicants: Hyundai Motor Company, Seoul (KR); Kia Corporation, Seoul (KR)

(72) Inventors: Han Nah Song, Hwaseong-si (KR); Min Ju Kim, Hwaseong-si (KR); You Seok Song, Hwaseong-si (KR)

(21) Appl. No.: 19/241,521

(22) Filed: Jun. 18, 2025

(30) Foreign Application Priority Data
Dec. 23, 2024 (KR) 1020240193495

(51) Int. Cl. B05C 19/06; B05C 19/04; B65G 27/18

(52) U.S. Cl. CPC B05C 19/06; B05C 19/04; B65G 27/18; B65G 2201/042; B65G 2812/0312

(57) ABSTRACT

A powder supply device is configured to manufacture dry electrodes. The powder supply device is configured to continuously supply cohesive powder used in manufacturing the dry electrodes to an electrode manufacturing device while evenly dispersing the powder using vibration feeders. The vibration feeders have, on a bottom plate of each of the vibration feeders, a plurality of supply amount adjustment grooves arranged at an equal interval in a width direction. The vibration feeders are configured to move the powder along each of the supply amount adjustment grooves and to continuously supply a predetermined amount of powder to the electrode manufacturing device.

### CROSS-REFERENCE TO RELATED APPLICATION

This application claims, under 35 U.S.C. § 119(a), the benefit of priority from Korean Patent Application No. 10-2024-0193495, filed on Dec. 23, 2024, the entire contents of which are incorporated herein by reference.

### TECHNICAL FIELD

The present disclosure relates to a powder supply device configured to manufacture dry electrodes, and more particularly, to a powder supply device configured to manufacture dry electrodes, in which the powder supply device is capable of uniformly dispersing powder used in manufacturing the dry electrodes without cohesion of the powder and continuously supplying a constant amount of the uniformly dispersed powder to an electrode substrate.

### BACKGROUND

Dry electrodes for batteries may be manufactured through various processes including a process of supplying powder mixed with an active material, a conductive material, and a binder to an electrode substrate through a powder movement path, a process of evenly applying the powder to the electrode substrate using a squeegee, and a process of compressing the powder using a compression roller so as to attach the powder to the electrode substrate.

When the dry electrodes for batteries are manufactured through the processes, it may be important to ensure a uniform thickness and a constant supply amount of powder to be supplied onto the electrode substrate.

In some cases, where powder is used in manufacturing dry electrodes, powder may be mixed with an active material, a conductive material, and a binder providing cohesion. It may be important to evenly distribute the powder from a powder storage hopper to an electrode manufacturing device and to supply a constant amount of the powder.

In some cases, where the powder used in manufacturing dry electrodes has high cohesion and poor flowability, powder particles may stick to each other or stagnate in a powder movement path between the powder storage hopper and the electrode manufacturing device. In some cases, it may be difficult to continuously supply, to the electrode manufacturing device, a constant amount of powder having a uniform thickness in a state in which powder is evenly dispersed.

In some cases, the outlet of the powder storage hopper may be frequently clogged, or the powder movement path connected to the outlet of the powder storage hopper may be frequently clogged. As a result, the constant amount of powder may not be continuously supplied to the electrode manufacturing device, causing various problems such as deterioration in productivity of dry electrodes and deterioration in quality of dry electrodes.

### SUMMARY

The present disclosure describes a powder supply device configured to manufacture dry electrodes, in which the powder supply device can be configured to continuously supply cohesive powder used in manufacturing the dry electrodes to an electrode manufacturing device while evenly dispersing the powder using a plurality of vibration feeders. The vibration feeders can have, in a bottom plate of each of the vibration feeders, a plurality of supply amount adjustment grooves arranged at an equal interval therebetween in the width direction and configured to move the powder to the electrode manufacturing device in a state in which the powder fills each of the supply amount adjustment grooves, and to continuously supply the constant amount of powder to the electrode manufacturing device.

According to one aspect of the subject matter described in this application, a powder supply device is configured to provide powder for manufacturing dry electrodes. The powder supply device comprises a powder storage hopper configured to store powder for manufacturing the dry electrodes and to discharge the powder, a powder metering supply device configured to measure and discharge a predetermined amount of the powder discharged from the powder storage hopper, a first vibration feeder configured to disperse the powder discharged from the powder metering supply device, a second vibration feeder that is arranged at an outlet of the first vibration feeder and configured to receive the powder discharged from the first vibration feeder, the second vibration feeder having a plurality of first supply amount adjustment grooves that are defined at a bottom plate of the second vibration feeder and arranged at an equal interval in a width direction, and a third vibration feeder that is arranged at an outlet of the second vibration feeder and configured to receive the powder discharged from the second vibration feeder, the third vibration feeder having a plurality of second supply amount adjustment grooves that are defined at a bottom plate of the third vibration feeder and arranged at an equal interval in the width direction.

Implementations according to this aspect can include one or more of the following features. For example, each of the plurality of first and second supply amount adjustment grooves can have an inverted triangle cross-sectional shape and be configured to receive the powder therein. In some examples, each of the plurality of first and second supply amount adjustment grooves can define an inner wall surface inclination angle that is greater than an angle of repose of a pile of the powder.

In some implementations, the first vibration feeder can include a bottom plate configured to receive the powder discharged from the powder metering supply device, and a first thickness adjustment plate that connects sides of the first vibration feeder to each other, that is spaced apart from a bottom plate of the first vibration feeder by a predetermined distance, and that is configured to provide the powder having a predetermined thickness. For instance, the predetermined thickness of the powder on the bottom plate of the first vibration feeder can be constant.

In some implementations, the second vibration feeder can include at least two second thickness adjustment plates that connect sides of the second vibration feeder to each other, that are spaced apart from the bottom plate of the second vibration feeder by a predetermined distance, and that are configured to provide the powder having a predetermined thickness, where the at least two second thickness adjustment plates are configured to guide the powder toward each of the plurality of first supply amount adjustment grooves. For instance, the predetermined thickness of the powder on the bottom plate of the second vibration feeder can be constant.

In some implementations, the third vibration feeder can include at least two third thickness adjustment plates that connect sides of the third vibration feeder to each other, that are spaced apart from the bottom plate of the third vibration feeder by a predetermined distance, and that are configured to provide the powder having a predetermined thickness, where the at least two third thickness adjustment plates are configured to guide the powder to each of the plurality of second supply amount adjustment grooves. For example, the predetermined thickness of the powder on the bottom plate of the third vibration feeder can be constant.

In some implementations, the first vibration feeder, the second vibration feeder, and the third vibration feeder can be inclined downwards at a predetermined slope along a movement direction of the powder. In some examples, a width of the second vibration feeder can be greater than a width of the first vibration feeder in the width direction, and a width of the third vibration feeder can be greater than the width of the second vibration feeder in the width direction.

In some implementations, the first vibration feeder can include a first vibration device disposed at a lower portion of the first vibration feeder and configured to provide vibration to the first vibration feeder in an up-down direction. The second vibration feeder can include a second vibration device disposed at a lower portion of the second vibration feeder and configured to provide vibration to the second vibration feeder in the up-down direction, and the third vibration feeder can include a third vibration device disposed at a lower portion of the third vibration feeder and configured to provide vibration to the third vibration feeder in the up-down direction.

In some implementations, each of the first, second, and third vibration devices can include a vibration plate attached to a bottom surface of a corresponding one of the first vibration feeder, the second vibration feeder, and the third vibration feeder, a shock absorber disposed on a ground, a base plate supported by the shock absorber, a vibration motor disposed at the base plate, a spring that connects the vibration plate to the base plate, and a reciprocating shaft that connects an output end of the vibration motor to the vibration plate and is configured to transmit vibration from the vibration motor to the vibration plate.

In some implementations, the powder supply device can further include a powder spreader disposed at an outlet of the third vibration feeder, the powder spreader being configured to vibrate in the width direction and hinder cohesion of the powder to be supplied to an electrode manufacturing device. In some examples, the powder spreader can include a first mesh plate that defines a plurality of first holes having a first mesh size, and a second mesh plate that defines a plurality of second holes having a second mesh size different from the first mesh size, where the first mesh plate and the second mesh plate are vertically stacked. In some examples, the second mesh size can be less than the first mesh size. In some implementations, a width of the powder spreader can be greater than the width of the third vibration feeder in the width direction.

In some examples, the second vibration feeder can accommodate at least a portion of the first vibration feeder, and the third vibration feeder can accommodate at least a portion of the second vibration feeder. In some examples, the powder metering supply device can have a cylindrical shape. In some examples, a diameter of the powder metering supply device can be greater than a width of the first vibration feeder and less than a width of the second vibration feeder, where a width of the second vibration feeder is greater than the width of the first vibration feeder in the width direction, and a width of the third vibration feeder is greater than the width of the second vibration feeder in the width direction.

It is understood that the terms “vehicle,” “vehicular,” and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to certain implementations thereof illustrated in the accompanying drawings which are given hereinbelow by way of illustration only, and thus are not limitative of the present disclosure.

FIG. 1 is a side view showing an example of a powder supply device configured to supply powder for manufacturing dry electrodes.

FIG. 2 is a plan view of the powder supply device.

FIG. 3 is a cross-sectional view taken along line A-A of FIG. 2.

FIG. 4 is a cross-sectional view taken along line B-B of FIG. 2.

FIG. 5 is a cross-sectional view taken along line C-C of FIG. 2.

FIG. 6 is a cross-sectional view showing an example of an inclination angle of a supply amount adjustment groove defined at a vibration feeder of the powder supply device, where the inclination angle is larger than an angle of repose of the powder.

FIG. 7 is a schematic view showing an example of a vibration device configured to vibrate the vibration feeder of the powder supply device.

In the figures, reference numbers refer to the same or equivalent parts of the present disclosure throughout the several figures of the drawing.

### DETAILED DESCRIPTION

Hereinafter, reference will be made in detail to one or more implementations of the present disclosure, examples of which are illustrated in the accompanying drawings and described below.

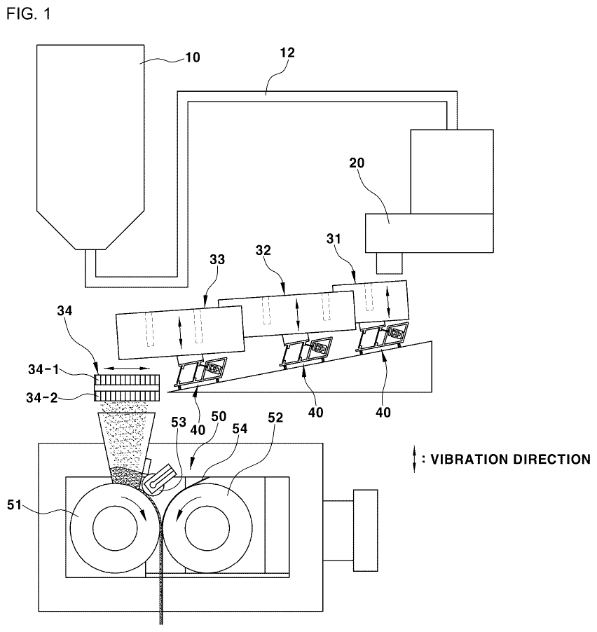

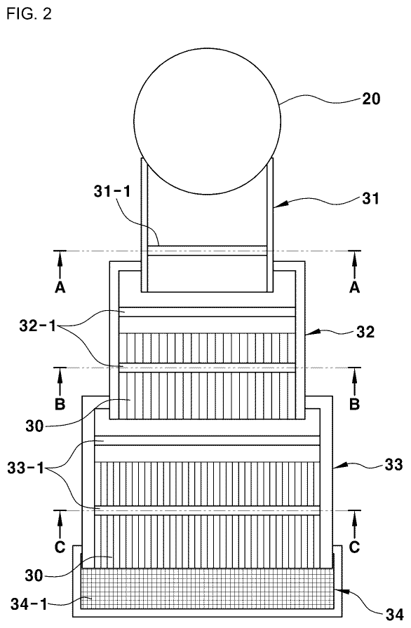

FIG. 1 is a side view showing an example of a powder supply device configured to provide powder for manufacturing dry electrodes, and FIG. 2 is a plan view of the powder supply device.

As shown in FIGS. 1 and 2, in some implementations, the powder supply device can include a powder storage hopper 10, a powder metering supply device 20, a powder supply line 12 connecting the powder storage hopper 10 to the powder metering supply device 20, a first vibration feeder 31, a second vibration feeder 32, and a third vibration feeder 33 that are sequentially arranged from the outlet of the powder metering supply device 20.

For example, the powder storage hopper 10 can store powder used in manufacturing dry electrodes for a battery, where the powder is mixed with an active material, a conductive material, and a binder and stored in the powder storage hopper 10.

In some examples, the powder metering supply device 20 can include a metering valve and the like and be configured to measure a predetermined amount of the powder discharged from the powder storage hopper 10 and then discharge the powder to the first vibration feeder 31. In some examples, the powder metering supply device 20 can include a storage, a container, a tank, a drum, or the like. In some cases, the powder metering supply device 20 can have a cylindrical shape having a diameter in the width direction of the vibration feeders. In some cases, the diameter can be greater than the width of the first vibration feeder 31 and less than the width of the second vibration feeder 32.

The first vibration feeder 31, the second vibration feeder 32, and the third vibration feeder 33 are arranged to be inclined downwards at a predetermined slope in a direction in which powder is moved. In some examples, the powder can be moved from the first vibration feeder 31 to the third vibration feeder 33 via the second vibration feeder 32.

In addition, the first vibration feeder 31, the second vibration feeder 32, and the third vibration feeder 33 are arranged in multiple stages while overlapping each other in a state in which the front outlet of the first vibration feeder 31 is disposed on the rear end of the second vibration feeder 32, and the front outlet of the second vibration feeder 32 is disposed on the rear end of the third vibration feeder 33, thereby enabling the powder to be readily moved from the first vibration feeder 31 to the third vibration feeder 33 via the second vibration feeder 32 without separation of the powder.

The first vibration feeder 31 is disposed below the outlet of the powder metering supply device 20, and a vibration device 40 configured to vibrate the first vibration feeder 31 in the upward-and-downward direction is mounted at the lower portion of the first vibration feeder 31.

In some examples, while the first vibration feeder 31 vibrates upwards and downwards by vibration driving of the vibration device 40, the powder discharged from the powder metering supply device 20 is evenly dispersed in the first vibration feeder 31 so as to prevent cohesion of the powder. In this manner, the powder is discharged from the first vibration feeder 31 to the second vibration feeder 32.

In some implementations, since the width of the second vibration feeder 32 is formed to be larger than that of the first vibration feeder 31, the powder can be readily discharged from the first vibration feeder 31 to the second vibration feeder 32 without separation of the powder.

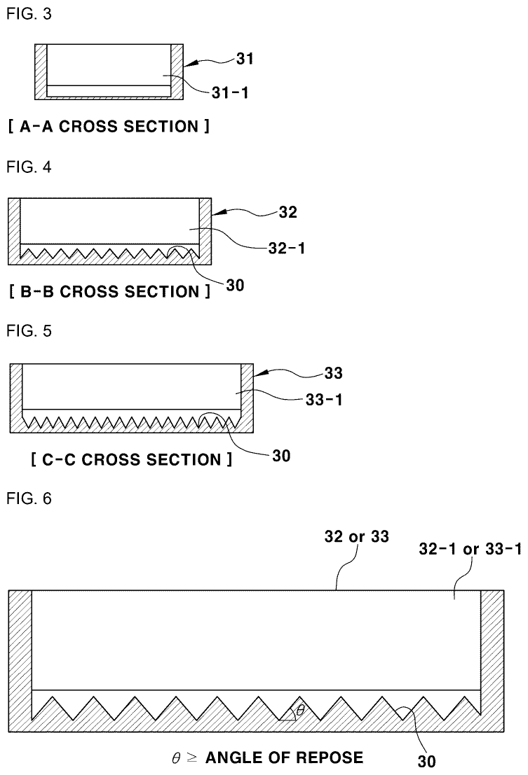

In this case, as shown in FIGS. 2 and 3, a first thickness adjustment plate 31-1 connects opposite sides of the first vibration feeder 31 to each other in a state of being spaced apart from the bottom plate of the first vibration feeder 31 by a predetermined distance. The first thickness adjustment plate 31-1 has a function of forming the constant thickness of the powder so as to prevent the powder from being unevenly accumulated in the first vibration feeder 31.

In some examples, when the powder discharged from the powder metering supply device 20 onto the bottom plate of the first vibration feeder 31 is moved toward the outlet of the first vibration feeder 31 by vibration driving of the vibration device 40, the thickness of the powder can be uniformly adjusted while the powder passes through the first thickness adjustment plate 31-1 without uneven accumulation of the powder in the first vibration feeder 31. As a result, a constant amount of powder adjusted to the uniform thickness can be continuously discharged to the second vibration feeder 32.

The second vibration feeder 32 is disposed below the outlet of the first vibration feeder 31 and has a plurality of supply amount adjustment grooves 30 disposed on the bottom plate thereof and arranged with an equal interval therebetween in the width direction. In some examples, the supply amount adjustment grooves are filled with the powder discharged from the first vibration feeder 31. The vibration device 40 configured to vibrate the second vibration feeder 32 in the upward-and-downward direction is mounted at the lower portion of the second vibration feeder 32.

In particular, as shown in FIG. 4, each of the supply amount adjustment grooves 30 formed in the bottom plate of the second vibration feeder 32 is formed to have an inverted triangle cross-sectional shape so as to allow the powder to readily fill the supply amount adjustment grooves. As shown in FIG. 6, an inner wall inclination angle θ of each of the supply amount adjustment grooves 30 is formed to be larger than an angle of repose.

For reference, the angle of repose is an angle at which accumulated powder is stably maintained for a long period of time without collapsing when powder is accumulated on a horizontal plane, and refers to an angle between the horizontal plane and the inclined plane of the accumulated powder. That is, the angle of repose is the maximum angle of a slope at which a granular material can be piled without slumping or sliding down.

In this manner, each of the supply amount adjustment grooves 30 formed in the bottom plate of the second vibration feeder 32 is formed to have the inverted triangle cross-sectional shape, and the inner wall inclination angle θ of each of the supply amount adjustment grooves 30 is formed to be larger than the angle of repose, thereby enabling the powder to be readily moved downwards along the inclined surface of each of the supply amount adjustment grooves 30 of the second vibration feeder 32. In some examples, the powder can be accumulated in each of the supply amount adjustment grooves 30 of the second vibration feeder 32.

In some examples, when the powder discharged from the first vibration feeder 31 is moved downwards to the second vibration feeder 32, the second vibration feeder 32 vibrates upwards and downwards by vibration driving of the vibration device 40 and as such, the powder is evenly dispersed without cohesion of the powder in the second vibration feeder 32. Then, the dispersed powder is moved to the third vibration feeder 33 in a state of filling each of the supply amount adjustment grooves 30 of the second vibration feeder 32.

In some implementations, since the width of the third vibration feeder 33 is formed to be larger than that of the second vibration feeder 32, the powder can be readily discharged from the second vibration feeder 32 to the third vibration feeder 33 without separation of the powder.

In some examples, at least two second thickness adjustment plates 32-1 connect opposite sides of the second vibration feeder 32 to each other in a state of being spaced apart from the bottom plate of the second vibration feeder 32 by a predetermined distance. Each of the second thickness adjustment plates 32-1 has a function of forming the constant thickness of the powder so as to prevent the powder from being unevenly accumulated in the second vibration feeder 32.

In some examples, when the powder discharged from the first vibration feeder 31 onto the bottom plate of the second vibration feeder 32 is moved toward the outlet of the second vibration feeder 32 by vibration driving of the vibration device 40, the thickness of the powder can be uniformly adjusted while the powder passes through the second thickness adjustment plate 32-1 without uneven accumulation of the powder in the second vibration feeder 32. As a result, a constant amount of powder adjusted to the uniform thickness can be continuously discharged to the third vibration feeder 33 in a state in which the powder fills each of the supply amount adjustment grooves 30 of the second vibration feeder 32.

The third vibration feeder 33 is disposed below the outlet of the second vibration feeder 32 and has a plurality of supply amount adjustment grooves 30 disposed on the bottom plate thereof and arranged with an equal interval therebetween in the width direction. In some examples, the supply amount adjustment grooves are filled with the powder discharged from the second vibration feeder 32. The vibration device 40 configured to vibrate the third vibration feeder 33 in the upward-and-downward direction is mounted at the lower portion of the third vibration feeder 33.

In some implementations, as shown in FIG. 5, each of the supply amount adjustment grooves 30 formed in the bottom plate of the third vibration feeder 33 is formed to have an inverted triangle cross-sectional shape so as to allow the powder to readily fill the supply amount adjustment grooves. As shown in FIG. 6, an inner wall inclination angle θ of each of the supply amount adjustment grooves 30 is formed to be larger than an angle of repose.

For example, each of the supply amount adjustment grooves 30 formed in the bottom plate of the third vibration feeder 33 is formed to have the inverted triangle cross-sectional shape, and the inner wall inclination angle θ of each of the supply amount adjustment grooves 30 is formed to be larger than the angle of repose, thereby enabling the powder to be readily moved downwards along the inclined surface of each of the supply amount adjustment grooves 30 of the third vibration feeder 33. In some examples, the powder can be accumulated in each of the supply amount adjustment grooves 30 of the third vibration feeder 33.

In some examples, when the powder discharged from the second vibration feeder 32 is moved downwards to the third vibration feeder 33, the third vibration feeder 33 vibrates upwards and downwards by vibration driving of the vibration device 40 and as such, the powder is evenly dispersed without cohesion of the powder in the third vibration feeder 33. Then, the dispersed powder is moved to a powder spreader 34 in a state in which the powder fills each of the supply amount adjustment grooves 30 of the third vibration feeder 33.

In some examples, at least two third thickness adjustment plates 33-1 connect opposite sides of the third vibration feeder 33 to each other in a state of being spaced apart from the bottom plate of the third vibration feeder 33 by a predetermined distance. Each of the third thickness adjustment plates 33-1 has a function of forming the constant thickness of the powder so as to prevent the powder from being unevenly accumulated in the third vibration feeder 33.

In some examples, when the powder discharged from the second vibration feeder 32 onto the bottom plate of the third vibration feeder 33 is moved toward the outlet of the third vibration feeder 33 by vibration driving of the vibration device 40, the thickness of the powder can be uniformly adjusted while the powder passes through the third thickness adjustment plate 33-1 without uneven accumulation of the powder in the third vibration feeder 33. As a result, a constant amount of powder adjusted to the uniform thickness can be continuously discharged to the powder spreader 34 in a state in which the powder fills each of the supply amount adjustment grooves 30 of the third vibration feeder 33.

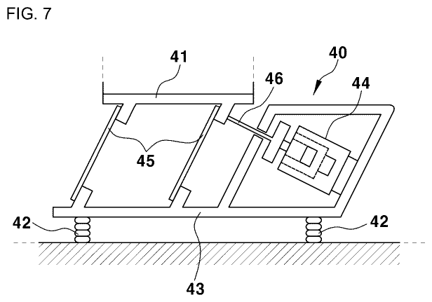

In some implementations, as shown in FIG. 7, the vibration device 40 configured to vibrate each of the first vibration feeder 31, the second vibration feeder 32, and the third vibration feeder 33 in the upward-and-downward direction can include a vibration plate 41 attached to the bottom surface of the bottom plate of each of the first vibration feeder 31, the second vibration feeder 32, and the third vibration feeder 33, a base plate 43 supported by a shock absorber 42 on the ground, a vibration motor 44 mounted on one side of the base plate 43, a spring 45 connecting the vibration plate 41 to the base plate 43, and a reciprocating shaft 46 configured to provide vibration and to connect an output part of the vibration motor 44 to the vibration plate 41.

In some examples, the reciprocating shaft 46 configured to provide vibration performs reciprocation motion by driving of the vibration motor 44 so as to pull or push the vibration plate 41 in the upward-and-downward direction. In some examples, elastic force of the spring 45 provides vibration force to the vibration plate 41, thereby enabling vibration of the first vibration feeder 31, the second vibration feeder 32, and the third vibration feeder 33, each having the vibration plate 41 attached thereto, in the upward-and-downward direction. For example, the spring 45 can include fiberglass, a plate spring, a coil spring, etc.

The powder spreader 34 can be located below the outlet of the third vibration feeder 33 so as to be vibrated left and right by a vibrator. In some examples, the powder spreader 34 can include a mesh-type plate structure configured to prevent or reduce cohesion of the powder to be supplied to an electrode manufacturing device 50.

In some implementations, the powder spreader 34 can include a first mesh plate 34-1 and a second mesh plate 34-2 that each define a plurality of holes having different mesh sizes and that are vertically stacked so as to allow the powder to pass through the first mesh plate 34-1 and the second mesh plate 34-2 without or less cohesion of the powder. For example, the mesh size of the second mesh plate 34-2 can smaller than that of the first mesh plate 34-1. In some examples, a width of the powder spreader 34 can be greater than the width of the third vibration feeder 33 in the width direction.

In some examples, while the powder falling from the outlet of the third vibration feeder 33 passes through the first mesh plate 34-1 and second mesh plate 34-2 of the powder spreader 34, cohesion between powder particles can be removed or reduced.

Therefore, a certain amount of powder filling the supply amount adjustment groove 30 of the third vibration feeder 33 is continuously dropped to the powder spreader 34 and then is moved to the electrode manufacturing device 50 via the powder spreader 34, thereby making it possible not only to prevent or reduce cohesion of the powder until the powder is finally supplied to the electrode manufacturing device 50, but also to allow the certain amount of powder to be continuously supplied to the electrode manufacturing device 50 while passing through the powder spreader 34. For example, the amount of powder can be predetermined.

In some implementations, the electrode manufacturing device 50 is configured to include a first compression roller 51, a second compression roller 52, and a squeegee 53 arranged on the outer periphery of the first compression roller 51.

In some examples, dry electrodes for a battery can be manufactured through a process of adjusting, by the squeegee 53, the powder supplied to the first compression roller 51 through the powder spreader 34 to a constant thickness, and a process of compressing and attaching the powder to an electrode substrate 54 when the powder adjusted to the constant thickness and the electrode substrate 54 pass through a space between the first and second compression rollers 51 and 52.

As is apparent from the above description, the present disclosure provides the following effects.

In some implementations, a cohesive powder used in manufacturing dry electrodes is evenly dispersed by a plurality of vibration feeders and is continuously supplied to an electrode manufacturing device, thereby preventing cohesion and stagnation of the powder supplied to the electrode manufacturing device.

In some implementations, multiple supply amount adjustment grooves each having an inverted triangular cross-sectional shape are arranged with an equal interval therebetween in the width direction on the bottom plate of each of the vibration feeders, thereby enabling the powder to be moved to the electrode manufacturing device in a state in which the powder fills each of the supply amount adjustment grooves. In this manner, a constant amount of powder can be continuously supplied to the electrode manufacturing device and as such, productivity and quality of the dry electrodes can be improved.

In some implementations, a mesh-type powder spreader configured to vibrate left and right is disposed at the outlet of the last vibration feeder among the multiple vibration feeders, thereby allowing the powder finally supplied to the electrode manufacturing device to pass through the powder spreader. It can be possible not only to prevent cohesion of the powder until the powder is finally supplied to the electrode manufacturing device, but also to improve productivity and quality of the dry electrodes.

Although the present disclosure has been described in detail with reference to implementations thereof, the scope of the present disclosure is not limited to the above-described implementations and the accompanying drawings, and it will be appreciated by those skilled in the art that various modifications and improvements can be made in the implementations without departing from the principles and spirit of the disclosure, the scope of which is defined in the appended claims and equivalents thereto.

What is claimed is:

1. A powder supply device configured to provide powder for manufacturing dry electrodes, the powder supply device comprising:
a powder storage hopper configured to store the powder for manufacturing the dry electrodes and to discharge the powder;
a powder metering supply device configured to measure and discharge a predetermined amount of the powder discharged from the powder storage hopper;
a first vibration feeder configured to disperse the powder discharged from the powder metering supply device;
a second vibration feeder that is arranged at an outlet of the first vibration feeder and configured to receive the powder discharged from the first vibration feeder, the second vibration feeder having a plurality of first supply amount adjustment grooves that are defined at a bottom plate of the second vibration feeder and arranged at an equal interval in a width direction; and
a third vibration feeder that is arranged at an outlet of the second vibration feeder and configured to receive the powder discharged from the second vibration feeder, the third vibration feeder having a plurality of second supply amount adjustment grooves that are defined at a bottom plate of the third vibration feeder and arranged at an equal interval in the width direction.

2. The powder supply device of claim 1, wherein each of the plurality of first and second supply amount adjustment grooves has an inverted triangle cross-sectional shape and is configured to receive the powder therein.

3. The powder supply device of claim 2, wherein each of the plurality of first and second supply amount adjustment grooves defines an inner wall surface inclination angle that is greater than an angle of repose of the powder.

4. The powder supply device of claim 1, wherein the first vibration feeder comprises:
a bottom plate configured to receive the powder discharged from the powder metering supply device; and
a first thickness adjustment plate that connects sides of the first vibration feeder to each other, that is spaced apart from a bottom plate of the first vibration feeder by a predetermined distance, and that is configured to provide the powder having a predetermined thickness.

5. The powder supply device of claim 4, wherein the predetermined thickness of the powder on the bottom plate of the first vibration feeder is constant.

6. The powder supply device of claim 1, wherein the second vibration feeder further comprises at least two second thickness adjustment plates that connect sides of the second vibration feeder to each other, that are spaced apart from the bottom plate of the second vibration feeder by a predetermined distance, and that are configured to provide the powder having a predetermined thickness, and
wherein the at least two second thickness adjustment plates are configured to guide the powder toward each of the plurality of first supply amount adjustment grooves.

7. The powder supply device of claim 6, wherein the predetermined thickness of the powder on the bottom plate of the second vibration feeder is constant.

8. The powder supply device of claim 1, wherein the third vibration feeder further comprises at least two third thickness adjustment plates that connect sides of the third vibration feeder to each other, that are spaced apart from the bottom plate of the third vibration feeder by a predetermined distance, and that are configured to provide the powder having a predetermined thickness, and
wherein the at least two third thickness adjustment plates are configured to guide the powder to each of the plurality of second supply amount adjustment grooves.

9. The powder supply device of claim 8, wherein the predetermined thickness of the powder on the bottom plate of the third vibration feeder is constant.

10. The powder supply device of claim 1, wherein the first vibration feeder, the second vibration feeder, and the third vibration feeder are inclined downwards at a predetermined slope along a movement direction of the powder.

11. The powder supply device of claim 1, wherein a width of the second vibration feeder is greater than a width of the first vibration feeder in the width direction, and
wherein a width of the third vibration feeder is greater than the width of the second vibration feeder in the width direction.

12. The powder supply device of claim 1, wherein the first vibration feeder comprises a first vibration device disposed at a lower portion of the first vibration feeder and configured to provide vibration to the first vibration feeder in an up-down direction,
wherein the second vibration feeder comprises a second vibration device disposed at a lower portion of the second vibration feeder and configured to provide vibration to the second vibration feeder in the up-down direction, and
wherein the third vibration feeder comprises a third vibration device disposed at a lower portion of the third vibration feeder and configured to provide vibration to the third vibration feeder in the up-down direction.

13. The powder supply device of claim 12, wherein each of the first, second, and third vibration devices comprises:
a vibration plate attached to a bottom surface of a corresponding one of the first vibration feeder, the second vibration feeder, and the third vibration feeder;
a shock absorber disposed on a ground;
a base plate supported by the shock absorber;
a vibration motor disposed at the base plate;
a spring that connects the vibration plate to the base plate; and
a reciprocating shaft that connects an output end of the vibration motor to the vibration plate and is configured to transmit vibration from the vibration motor to the vibration plate.

14. The powder supply device of claim 1, further comprising a powder spreader disposed at an outlet of the third vibration feeder, the powder spreader being configured to vibrate in the width direction and hinder cohesion of the powder to be supplied to an electrode manufacturing device.

15. The powder supply device of claim 14, wherein the powder spreader comprises:
a first mesh plate that defines a plurality of first holes having a first mesh size; and
a second mesh plate that defines a plurality of second holes having a second mesh size different from the first mesh size, and
wherein the first mesh plate and the second mesh plate are vertically stacked.

16. The powder supply device of claim 15, wherein the second mesh size is less than the first mesh size.

17. The powder supply device of claim 14, wherein a width of the second vibration feeder is greater than a width of the first vibration feeder in the width direction,
wherein a width of the third vibration feeder is greater than the width of the second vibration feeder in the width direction, and
wherein a width of the powder spreader is greater than the width of the third vibration feeder in the width direction.

18. The powder supply device of claim 1, wherein the second vibration feeder accommodates at least a portion of the first vibration feeder, and
wherein the third vibration feeder accommodates at least a portion of the second vibration feeder.

19. The powder supply device of claim 1, wherein the powder metering supply device has a cylindrical shape.

20. The powder supply device of claim 18, wherein a diameter of the powder metering supply device is greater than a width of the first vibration feeder and less than a width of the second vibration feeder,
wherein a width of the second vibration feeder is greater than the width of the first vibration feeder in the width direction, and
wherein a width of the third vibration feeder is greater than the width of the second vibration feeder in the width direction.
